(19) United States
(12) Patent Application Publication
(10) Pub. No.: US 2026/0346272 A1
(43) Pub. Date: Nov. 5, 2026

(54) CLEANER

(71) Applicant: LG ELECTRONICS INC., Seoul (KR)

(72) Inventors: Inkyu HWANG, Seoul (KR); Kietak HYUN, Seoul (KR); Jaehun HAN, Seoul (KR); Junhyung LIM, Seoul (KR)

(73) Assignee: LG ELECTRONICS INC., Seoul (KR)

(21) Appl. No.: 19/486,852

(22) PCT Filed: May 21, 2024
(86) PCT No.: PCT/KR2024/006855

§ 371 Date: Nov. 21, 2025

(30) Foreign Application Priority Data
May 24, 2023 (KR) 10-2023-0067091

(51) Int. Cl. B04C 5/26; A47L 9/16; B04C 5/103; B04C 5/12; B04C 9/00

(52) U.S. Cl. CPC B04C 5/26; A47L 9/1608; A47L 9/1633; B04C 5/103; B04C 5/12; B04C 9/00; B04C 2009/005

(57) ABSTRACT

The present disclosure relates to a cleaner including a suction part, a dust separating part configured to separate dust from air sucked through the suction part, and a suction motor configured to provide a flow force of air, in which the dust separating part includes a first cyclone part configured to separate debris from the air sucked into the suction part, a second cyclone part configured to separate debris from the air having passed through the first cyclone part, and a third cyclone part configured to separate debris from the air having passed through the second cyclone part, in which any one of the second cyclone part and the third cyclone part is disposed to surround the other of the second cyclone part and the third cyclone part, and in which the first cyclone part is disposed to surround any one of the second cyclone part and the third cyclone part, thereby providing a three-stage cyclone structure.

### TECHNICAL FIELD

The present disclosure relates to a cleaner, and more particularly, to a cleaner that provides a three-stage cyclone structure.

### BACKGROUND ART

A cleaner refers to a device that cleans a target cleaning region by sucking dust or debris or wiping the target cleaning region.

In order to provide driving power for sucking dust, the cleaner includes an impeller, and a motor configured to rotate the impeller. The cleaner generates a suction force by reducing internal pressure by discharging inside air to the outside by operating the motor. The suction force, which is generated in this manner, sucks debris, such as dust, on a cleaning surface together with outside air by means of a suction means, and the outside air and the sucked debris may be removed by a dust collecting device or the like.

Depending on the shape of the cleaner, the cleaners may be classified into a canister cleaner, an upright cleaner, a handy cleaner, a stick cleaner, and the like.

A wireless vacuum cleaner uses a multi-cyclone dust collecting device, which uses a centrifugal force, as the dust collecting device for collecting dust and dirt.

The multi-cyclone dust collecting device includes a primary cyclone part configured to separate and collect dirt and dust from dirt-containing air introduced from the outside, and a plurality of secondary cyclone parts configured to separate fine dust from the air discharged from the primary cyclone part.

Meanwhile, Korean Patent No. KR2080013B discloses a vacuum cleaner having a multi-cyclone part.

The vacuum cleaner includes a primary cyclone part and a plurality of secondary cyclone parts, and a filter is installed between the primary cyclone part and the secondary cyclone part. Therefore, dust with a large size is separated from air.

In this case, in the vacuum cleaner, a flow path for air needs to be increased to improve separation performance. However, because a space in which a vacuum cyclone dust collecting device is installed in the vacuum cleaner is limited, there is a limitation in that the separation performance cannot be improved.

In addition, because the plurality of secondary cyclone parts are provided in the primary cyclone part, there is a problem in that a flow imbalance occurs between a center cyclone part and an outer peripheral cyclone part in the vacuum cyclone dust collecting device.

### DISCLOSURE

### Technical Problem

The present disclosure has been made in an effort to solve the above-mentioned problem with the cleaner in the related art, and an object of the present disclosure is to provide a cleaner having a three-stage cyclone structure.

In addition, another object of the present disclosure is to provide a cleaner in which a three-stage cyclone structure may be provided in a limited space, such that the high-performance cyclone structure having maximized separation performance may be provided, and even fine dust may be separated, which makes it unnecessary to install a filter in a dust separating part.

In particular, still another object of the present disclosure is to provide a cleaner in which no filter is installed in a dust separating part, such that a decrease in suction force caused by the use of the existing filter may be prevented, and costs required to install the filter may be reduced.

In addition, yet another object of the present disclosure is to provide a cleaner in which a three-stage cyclone structure provides an integrated arrangement in which second and third cyclone parts are configured in a first cyclone part, thereby improving separation performance without increasing a volume.

In addition, still yet another object of the present disclosure is to provide a cleaner in which the number of discharge ports of a dust separating part may be reduced, and the discharge ports may be disposed at a center of the dust separating part or arranged in a circular shape around the dust separating part, thereby minimizing a loss of a flow path.

In addition, a further object of the present disclosure is to provide a cleaner in which an axial-flow type, a tangential inflow type, or a tangential axial-flow type may be selectively applied as an air inflow structure of a second cyclone part and a third cyclone part, as necessary, thereby improving a degree of design freedom.

In addition, another further object of the present disclosure is to provide a cleaner in which a single second cyclone part or a single third cyclone part is disposed at a center of a dust separating part, and a plurality of third cyclone parts or a plurality of second cyclone parts surround the single second cyclone part or the single third cyclone part, such that an airflow is uniform.

The objects of the present disclosure are not limited to the aforementioned objects, and other objects, which are not mentioned above, may be clearly understood from the following descriptions.

### Technical Solution

In order to achieve the above-mentioned object, a cleaner according to the present disclosure may include: a suction part having a flow path through which air flows; a dust separating part configured to separate dust from air sucked through the suction part; and a suction motor configured to provide a flow force of air, in which the dust separating part includes: a first cyclone part configured to separate debris from the air sucked into the suction part; a second cyclone part configured to separate debris from the air having passed through the first cyclone part; and a third cyclone part configured to separate debris from the air having passed through the second cyclone part, in which any one of the second cyclone part and the third cyclone part is disposed to surround the other of the second cyclone part and the third cyclone part, and in which the first cyclone part is disposed to surround any one of the second cyclone part and the third cyclone part.

The second and third cyclone parts may each include: a first flow path through which the air flows along an axis parallel to a central axis of a cyclone flow; and a second flow path through which the air flows along an axis parallel to a central axis of a cyclone flow while flowing in a direction opposite to the first flow path, the second flow path being connected to the first flow path.

The air having passed through the first cyclone part may be introduced into the second cyclone part in an axial direction.

The air having passed through the second cyclone part may be introduced into the third cyclone part in the axial direction or a tangential direction.

The air having passed through the first cyclone part may be introduced into the second cyclone part in a tangential direction.

The air having passed through the second cyclone part may be introduced into the third cyclone part in an axial direction or the tangential direction.

The dust separating part may have a plurality of discharge ports configured to discharge the air having passed through the third cyclone part, and the discharge ports may be arranged in the dust separating part in a circumferential direction.

The dust separating part may have a discharge port configured to discharge the air having passed through the third cyclone part, and the discharge port may be formed at a center of the dust separating part.

The dust separating part may further include: a first outer tube configured to provide any one of the second cyclone part and the third cyclone part; a first inner tube disposed inside the first outer tube; a plurality of second outer tubes arranged in a circumferential direction around the first outer tube and configured to provide the other of the second cyclone part and the third cyclone part; and a plurality of second inner tubes respectively disposed inside the second outer tubes.

The dust separating part may further include: a first separation wall having a discharge port configured to discharge the air, which has passed through the third cyclone part, toward the suction motor; and a second separation wall configured to connect the first inner tube and the second outer tube and define a flow space together with the first separation wall, and in which the air having passed through the second cyclone part flows to the third cyclone part through the flow space.

The dust separating part may further include: a first separation wall having a discharge port configured to discharge the air having passed through the third cyclone part; and a second separation wall configured to connect the second inner tube and the first outer tube and define a flow space together with the first separation wall, and in which the air having passed through the second cyclone part flows to the third cyclone part through the flow space.

The first separation wall may be disposed to be in contact with the second separation wall, the second separation wall may have a plurality of guide grooves recessed in a surface, with which the first separation wall is in contact, and formed to allow the plurality of second inner tubes and the first outer tube to communicate with one another, and a width of the guide groove may gradually decrease from the second inner tube toward the first outer tube.

The dust separating part may further include a housing in which the plurality of second outer tubes are disposed, the housing having at least one through-hole through which the air having passed through the first cyclone part flows.

An inlet and an outlet of each of the second and third cyclone parts may be disposed at an end of the outer tube adjacent to the suction motor.

The outer tube may have a guide vane having a spiral shape and protruding from an inner peripheral surface of the outer tube toward the inner tube.

The outer tube may have at least one slit provided at an end of the outer tube adjacent to the suction motor.

The first outer tube may be formed to have a diameter larger than a diameter of the second outer tube.

### Advantageous Effects

The cleaner of the present disclosure described above has one or more of the following effects.

According to the cleaner according to the present disclosure, the three-stage cyclone structure may be provided in a limited space, such that the high-performance cyclone structure having maximized separation performance may be provided, and even fine dust may be separated, which makes it unnecessary to install a filter in the dust separating part.

In particular, no filter is installed in the dust separating part, such that a decrease in suction force caused by the use of the existing filter may be prevented, and costs required to install the filter may be reduced.

In addition, the three-stage cyclone structure provides the integrated arrangement in which the second and third cyclone parts are configured in the first cyclone part, thereby improving separation performance without increasing the volume.

In addition, the number of discharge ports of the dust separating part may be reduced, and the discharge ports may be disposed at the center of the dust separating part or arranged in a circular shape around the dust separating part, thereby minimizing a loss of a flow path.

In addition, the axial-flow type, the tangential inflow type, or the tangential axial-flow type may be selectively applied as the air inflow structure of the second cyclone part and the third cyclone part, as necessary, thereby improving a degree of design freedom.

In addition, the single second cyclone part or the single third cyclone part is disposed at the center of the dust separating part, and the plurality of third cyclone parts or the plurality of second cyclone parts surround the single second cyclone part or the single third cyclone part, such that a uniform airflow may be provided.

### DESCRIPTION OF DRAWINGS

FIG. 1 is a schematic view of a cleaner according to the present disclosure.

FIG. 2 is a perspective view illustrating a cleaner main body according to the present disclosure.

FIG. 3 is a cross-sectional view for explaining a flow of air in the cleaner according to the present disclosure.

FIG. 4 is a view for explaining a dust separating part of a cleaner according to first to fifth embodiments of the present disclosure.

FIG. 5 is a cross-sectional view for explaining the dust separating part including an axial-flow type first cyclone unit and an axial-flow type second cyclone unit in the cleaner according to the first embodiment of the present disclosure.

FIG. 6 is a cross-sectional view for explaining the dust separating part including an axial-flow type first cyclone unit and a tangential inflow type second cyclone unit in the cleaner according to the second embodiment of the present disclosure.

FIG. 7 is a cross-sectional view taken along line 7-7 in FIG. 6.

FIG. 8 is a cross-sectional view for explaining the dust separating part including a tangential inflow type first cyclone unit and an axial-flow type second cyclone unit in the cleaner according to the third embodiment of the present disclosure.

FIG. 9 is a cross-sectional view taken along line 9-9 in FIG. 8.

FIG. 10 is a cross-sectional view for explaining the dust separating part including a tangential inflow type first cyclone unit and a tangential inflow type second cyclone unit in the cleaner according to the fourth embodiment of the present disclosure.

FIG. 11 is a cross-sectional view for explaining the dust separating part including a tangential axial-flow type first cyclone unit and a tangential axial-flow type second cyclone unit in the cleaner according to the fifth embodiment of the present disclosure.

FIG. 12 is a cross-sectional view taken along line 12-12 in FIG. 11.

FIG. 13 is a cross-sectional view taken along line 13-13 in FIG. 11.

FIG. 14 is a view for explaining a dust separating part of a cleaner according to sixth to ninth embodiments of the present disclosure.

FIG. 15 is a cross-sectional view for explaining the dust separating part including an axial-flow type first cyclone unit and an axial-flow type second cyclone unit in the cleaner according to the sixth embodiment of the present disclosure.

FIG. 16 is a cross-sectional view for explaining the dust separating part including a tangential inflow type first cyclone unit and an axial-flow type second cyclone unit in the cleaner according to the seventh embodiment of the present disclosure.

FIG. 17 is a cross-sectional view taken along line 17-17 in FIG. 16.

FIG. 18 is a cross-sectional view for explaining the dust separating part including an axial-flow type first cyclone unit and a tangential inflow type second cyclone unit in the cleaner according to the eighth embodiment of the present disclosure.

FIG. 19 is a cross-sectional view taken along line 19-19 in FIG. 18.

FIG. 20 is a cross-sectional view for explaining the dust separating part including a tangential inflow type first cyclone unit and a tangential inflow type second cyclone unit in the cleaner according to the ninth embodiment of the present disclosure.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terminology used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

Hereinafter, a cleaner according to the present specification will be described with reference to the accompanying drawings.

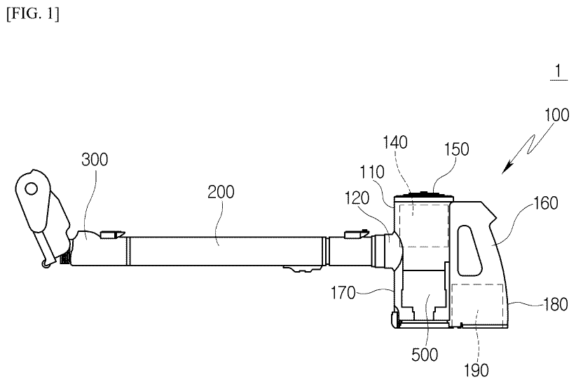

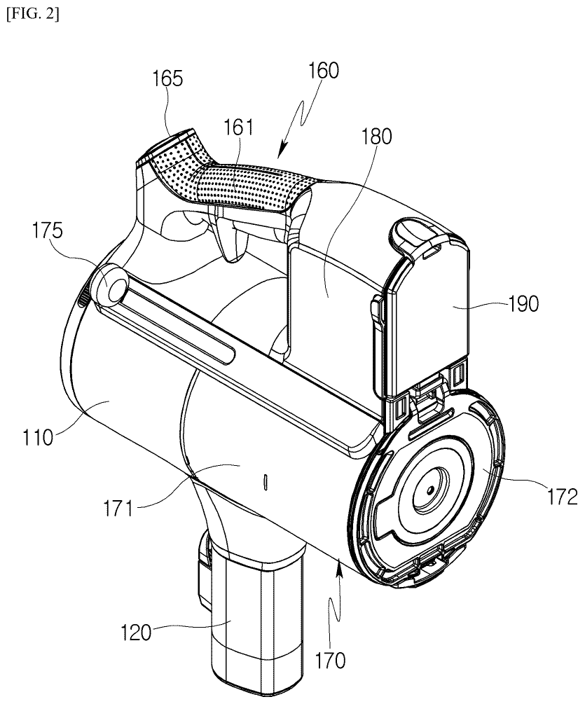

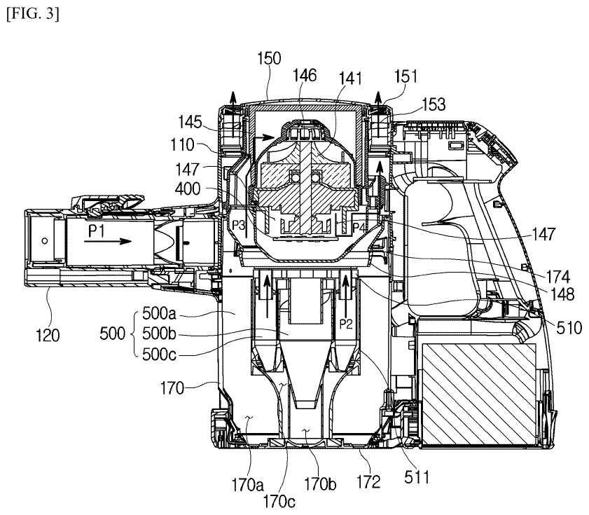

FIG. 1 is a schematic view of a cleaner according to the present disclosure, FIG. 2 is a perspective view illustrating a cleaner main body according to the present disclosure, and FIG. 3 is a cross-sectional view for explaining a flow of air in the cleaner according to the present disclosure.

Meanwhile, the term “floor surface” used in the present specification may refer to not only a floor surface of a room such as a living room but also a cleaning surface such as a carpet.

With reference to FIGS. 1 to 3, a cleaner 1 according to an embodiment of the present disclosure may include a cleaner main body 100 having a suction motor 140 configured to generate a suction force, a suction module 300 connected to the cleaner main body 100 and configured to suck air and debris on the floor surface, and an extension tube 200 configured to connect the cleaner main body 100 and the suction module 300.

A structure of the cleaner main body 100 will be described below.

Meanwhile, in the embodiment of the present disclosure, directions may be defined based on when a bottom surface (lower surface) of a dust bin 170 and a bottom surface (lower surface) of a battery housing 180 are placed on the ground surface.

In this case, a forward direction may refer to a direction in which a suction part 120 is disposed based on the suction motor 140, and a rearward direction may refer to a direction in which a handle 160 is disposed based on the suction motor 140. Further, based on a state in which the suction part 120 is viewed from the suction motor 140, a rightward direction may refer to a direction in which a component is disposed at the right side, and a leftward direction may refer to a direction in which a component is disposed at the left side. In addition, in the embodiment of the present disclosure, upper and lower sides may be defined in a direction perpendicular to the ground surface based on the state in which the bottom surface (lower surface) of the dust bin 170 and the bottom surface (lower surface) of the battery housing 180 are placed on the ground surface.

The cleaner 1 may include the cleaner main body 100. A flow path may be formed in the cleaner main body 100 and guide the sucked air so that the air is discharged to the outside.

Specifically, the cleaner main body 100 may include a main body housing 110, the suction part 120, a dust separating part 500, the suction motor 140, an air discharge cover 150, the handle 160, the dust bin 170, the battery housing 180, and a battery 190.

The main body housing 110 may define an external appearance of the cleaner main body 100. The main body housing 110 may provide a space that may accommodate the suction motor 140 and a prefilter 145. For example, the main body housing 110 may be formed in a shape similar to a cylindrical shape.

The suction part 120 may protrude outward from the main body housing 110. For example, the suction part 120 may be formed in a cylindrical shape with an opened inside. The suction part 120 may be coupled to the extension tube 200. The suction part 120 may provide a flow path P1 in which air containing dust may flow.

The dust separating part 500 may communicate with the suction part 120. The dust separating part 500 adopts a principle of a dust collector using a centrifugal force to separate the dust sucked into the cleaner main body 100 through the suction part 120. A space in the dust separating part 500 may communicate with a space in the dust bin 170.

For example, the dust separating part 500 may separate dust by using a cyclone flow. Further, the space in the dust separating part 500 may communicate with a flow path P2 formed in the suction part 120. Therefore, air and dust, which are sucked through the suction part 120, spirally flow along an inner circumferential surface of the dust separating part 500. Therefore, the cyclone flow may be generated in the internal space of the dust separating part 500.

The specific configuration and effect of the dust separating part 500 will be described below in detail.

The suction motor 140 may be disposed in the flow path and generate a flow force for moving the air in the flow path.

The suction motor 140 may have an impeller 141. A shaft of the suction motor 140 may be inserted into a center of the impeller 141 in an upward/downward direction. In this case, the shaft of the suction motor 140 may be fixed to the center of the impeller 141. With this configuration, when the suction motor 140 operates, the impeller 141 may rotate together with the shaft of the suction motor 140 and generate the flow force of the air.

For example, the suction motor 140 may include an annular stator, the shaft configured to penetrate the center of the stator, and a rotor axially installed on the shaft and configured to generate a rotational force together with the stator. Meanwhile, in the present embodiment, a brushless direct current motor (BLDC motor) is used as the suction motor 140. However, the present disclosure is not limited thereto. Various types of motors may be applied.

The suction motor 140 may suck air through an air suction port 146 provided in an upper central portion of a housing of the suction motor 140 and discharge the air through an air discharge port 147 provided in a circumferential direction at a lower side of the suction motor 140. With this configuration, the air flowing in the suction motor 140 may effectively dissipate heat from heating elements mounted on a printed circuit board.

The cleaner 1 may include the prefilter 145 configured to filter the air before the air is sucked into the suction motor 140. For example, the prefilter 145 may be disposed to surround the impeller 141. For example, the air in a suction flow path P3 may pass through the prefilter 145 and reach the impeller 141. The prefilter 145 may be disposed in the cleaner main body 100. The prefilter 145 may be disposed below the air discharge cover 150. A user may separate the air discharge cover 150 from the main body housing 110 and withdraw the prefilter 145 from the inside of the cleaner main body 100.

The cleaner main body 100 may include an air guide 148 configured to guide the air discharged from the dust separating part 500. The air guide 148 may be disposed between the main body housing 110 and the housing of the suction motor 140. The air guide 148 may define the suction flow path P3 configured to guide the air from the dust separating part 500 to the impeller 141. The air guide 148 may define an air discharge flow path P4 configured to guide the air, which has passed through the impeller 141, to an air discharge port 151.

With this configuration, the air guide 148 may define the flow paths P3 and P4 so that the air discharged from the dust separating part 500 ascends, descends while passing through the impeller 141, and then ascends again to the air discharge port 151.

Therefore, for example, the air and dust, which are sucked through the flow path Pl in the suction part 120 by the operation of the suction motor 140, may be separated from each other while flowing through a flow path P2 in the dust separating part 500. The air, from which dust is separated by the dust separating part 130, may move upward and be introduced into the suction flow path P3 in a fan driving part. The suction flow path P3 may guide the air toward the prefilter 145. The air sequentially passing through the prefilter 145 and the impeller 141 may be introduced into the air discharge flow path P4 and discharged to the outside through the air discharge port 151 after passing through a HEPA filter 153.

Meanwhile, the cleaner 1 according to the embodiment of the present disclosure may include a printed circuit board (PCB) 400 configured to control the suction motor 140. The printed circuit board 400 may be disposed between the suction motor 140 and the dust separating part 500.

The air discharge cover 150 may define an external appearance of an upper side of the cleaner main body 100 and cover an upper side of the suction motor 140.

The air discharge cover 150 may be disposed at one side of the main body housing 110 based on an axial direction.

The air discharge port 151, through which the air in the flow path is discharged to the outside of the cleaner main body 100, may be formed in the air discharge cover 150.

For example, the air discharge port 151 may be disposed to be directed in a particular direction. For example, the plurality of air discharge ports 151 may be divided in the circumferential direction. The plurality of air discharge ports 151 may be arranged to be spaced apart from one another at predetermined intervals in the circumferential direction.

The air discharge cover 150 may accommodate a filter configured to filter the air before the air is discharged to the air discharge port 151. For example, the air discharge cover 150 may accommodate the HEPA filter 153.

The air having passed through the suction motor 140 may pass through the HEPA filter 153 and then be discharged to the outside through the air discharge port 151. The HEPA filter 153 may be disposed in the air discharge flow path P4.

The air discharge cover 150 may have a filter accommodation space for accommodating the HEPA filter 153. The filter accommodation space may be formed to be opened at a lower side thereof, and the HEPA filter 153 may be accommodated at the lower side of the air discharge cover 150.

The air discharge port 151 may be formed to face the HEPA filter 153. For example, the HEPA filter 153 may be disposed below the air discharge port 151. For example, the HEPA filter 153 may be disposed to extend in the circumferential direction along the air discharge port 151.

The handle 160 may be gripped by the user. The handle 160 may be disposed rearward of the suction motor 140. For example, the handle 160 may be formed in a shape similar to a cylindrical shape. Alternatively, the handle 160 may be formed in a curved cylindrical shape. The handle 160 may be disposed at a predetermined angle with respect to the main body housing 110, the suction motor 140, or the dust separating part 500.

The handle 160 may include a grip portion 161 formed in a column shape so that the user may grasp the grip portion 161, a first extension portion connected to one end of the grip portion 161 based on the longitudinal direction (axial direction) of the grip portion 161 and extending toward the suction motor 140, and a second extension portion connected to the other end of the grip portion 161 based on the longitudinal direction (axial direction) of the grip portion 161 and extending toward the dust bin 170.

An upper side of the handle 160 may define an external appearance of a part of an upper side of the cleaner 1. Therefore, it is possible to prevent a component of the cleaner 1 from coming into contact with the user's arm in case that the user grips the handle 160.

An operating part 165 may be disposed on the handle 160. The operating part 165 may be disposed on an inclined surface formed in an upper region of the handle 160. The user may input a command for operating or stopping the cleaner 1 through the operating part 165.

The dust bin 170 may be disposed below the main body housing 110. The dust separating part 500 may be accommodated in the dust bin 170. The dust bin 170 may communicate with the dust separating part 500. The dust bin 170 may store the dust separated by the dust separating part 500.

The dust bin 170 may include a dust bin main body 171.

The dust bin main body 171 may provide a space capable of storing the dust separated by the dust separating part 130. For example, the dust bin main body 171 may be formed in a shape similar to a cylindrical shape.

For example, the dust bin main body 171 may be configured such that a lower side of the dust bin main body 171 may be opened. In this case, a discharge cover 172 may be provided at the lower side of the dust bin main body 171 and selectively open the lower side of the dust bin main body 171.

The discharge cover 172 may be provided to open or close the lower side of the dust bin main body 171. The discharge cover 172 may be rotatably coupled to the lower side of the dust bin main body 171. The discharge cover 172 may be hingedly coupled to the dust bin main body 171 and open or close a lower side of the dust bin 170 while rotating.

Meanwhile, according to the embodiment, the dust bin 170 may further include a dust bin compression lever 173 and a compression member 174.

The dust bin compression lever 173 may be disposed outside the dust bin 170 or the dust separating part 130. The dust bin compression lever 173 may be disposed outside the dust bin 170 or the dust separating part 130 so as to be movable upward and downward. The dust bin compression lever 173 may be connected to the compression member 174. In case that the dust bin compression lever 173 is moved downward by an external force, the compression member 174 may also be moved downward. Therefore, it is possible to provide convenience for the user. The compression member 174 and the dust bin compression lever 173 may return back to original positions by an elastic member (not illustrated). Specifically, in case that the external force applied to the dust bin compression lever 173 is eliminated, the elastic member may move the dust bin compression lever 173 and the compression member 174 upward.

The compression member 174 may be disposed in the dust bin main body 171. The compression member 174 may move in the internal space of the dust bin main body 171. Specifically, the compression member 174 may move upward or downward in the dust bin main body 171. Therefore, the compression member may compress downward the dust in the dust bin main body 171. In addition, when the discharge cover 172 is separated from the dust bin main body 171 and thus the lower side of the dust bin 170 is opened, the compression member 174 may move from an upper side of the dust bin 170 to the lower side of the dust bin 170, thereby removing debris such as residual dust in the dust bin 170. Therefore, it is possible to improve the suction force of the cleaner by preventing the residual dust from remaining in the dust bin 170. Further, it is possible to remove an offensive odor caused by the residual dust by preventing the residual dust from remaining in the dust bin 170.

The battery 190 may be accommodated in the battery housing 180. The battery housing 180 may be disposed below the handle 160.

For example, the battery housing 180 may have a hexahedral shape opened at a lower side thereof. A rear side of the battery housing 180 may be connected to the handle 160. In this case, the battery housing 180 may include an accommodation portion opened at a lower side thereof. With this configuration, the battery 190 may be attached or detached through the accommodation portion of the battery housing 180.

In another example, the battery housing 180 and the battery 190 may be integrated in a state in which the battery housing 180 accommodates the battery 190.

The battery 190 serves to supply power to the cleaner 1. Specifically, the battery 190 may supply power to the suction motor 140 and supply power to an electronic circuit and an electronic component through electric wires embedded in the cleaner 1. In addition, the battery 190 may supply power to the suction module 300.

In a case in which the battery 190 is coupled to the battery housing 180, a lower side of the battery 190 may be exposed to the outside. Because the battery 190 may be placed on the floor when the cleaner 1 is placed on the floor, the battery 190 may be immediately separated from the battery housing 180. In addition, because the lower side of the battery 190 is exposed to the outside and thus in direct contact with the air present outside the battery 190, the performance in cooling the battery 190 may be improved.

Meanwhile, in case that the battery 190 is fixed integrally to the battery housing 180, the number of structures for attaching or detaching the battery 190 and the battery housing 180 may be reduced, and as a result, it is possible to reduce an overall size of the cleaner 1 and a weight of the cleaner 1.

Meanwhile, the cleaner 1 may include the extension tube 200.

The extension tube 200 may be coupled to the cleaner main body 100 and the suction module 300. One end of the extension tube 200 may be detachably coupled to the suction part 120. Further, the other end of the extension tube 200 may be detachably coupled to the suction module 300.

For example, the extension tube 200 may be formed in a long cylindrical shape. Therefore, an internal space of the extension tube 200 may communicate with an internal space of the cleaning module 300. In addition, the extension tube 200 may communicate with a suction flow path formed in the suction part 120 of the cleaner main body 100.

When the suction force is generated by the suction motor 140, the suction force may be provided to the suction module 300 through the suction part 120 and the extension tube 200. Therefore, outside dust and air may be introduced into the cleaner main body 100 through the cleaning module 300 and the extension tube 200. In addition, dust and air introduced through the suction module 300 may pass through the extension tube 200 and then be introduced into the cleaner main body 100. Further, the dust and air, which has been introduced into the cleaner main body 100 and has passed through the suction part 120, may be separated from the dust separating part 130, the dust may be stored in the dust bin 170, and the air may be discharged to the outside through the air discharge cover 150.

The suction module 300 may move along the floor surface and suck dust present on the floor surface. The suction module 300 may be connected to the cleaner main body 100 through the extension tube 200.

For example, the suction module 300 may have an agitator capable of guiding dust on the floor surface to the suction port while rotating. Alternatively, a rag (mop) may be further provided on the suction module 300 and configured to wipe the floor surface.

Meanwhile, although not illustrated, the suction module 300 may be connected directly to the cleaner main body 100 even without the extension tube 200.

Meanwhile, the dust separating part 500 is disposed in the dust bin 170 and disposed in a space that communicates with the flow path of the suction part 120 and the flow path of the suction motor 140 so that air flows in the space. Specifically, the dust separating part 500 may be disposed rearward of the suction part 120 and disposed below the suction motor 140.

The dust separating part 500 includes a first cyclone unit and at least one second cyclone unit and provides a three-stage cyclone structure together with the dust bin 170. The dust separating part 500 may provide a three-stage cyclone structure in a first cyclone part 500a, a second cyclone part 500b, and a third cyclone part 500c are connected in series. That is, the first cyclone part 500a separates debris from the air sucked into the suction part, and the second cyclone part 500b separates debris from the air having passed through the first cyclone part 500a. Further, the third cyclone part 500c may separate debris from the air having passed through the second cyclone part 500b and discharge the air through discharge ports 561.

In addition, the first cyclone part 500a, the second cyclone part 500b, and the third cyclone part 500c may be disposed inside the dust bin 170 and disposed at the same height based on when the dust bin 170 is placed on the floor surface. Specifically, the second cyclone part 500b and the third cyclone part 500c may be disposed inside the first cyclone part 500a, and any one of the second cyclone part 500b and the third cyclone part 500c may be disposed inside the other of the second cyclone part 500b and the third cyclone part 500c.

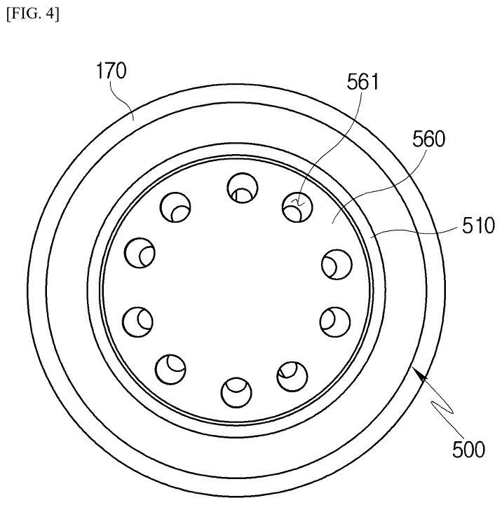

For example, as illustrated in FIGS. 4 to 13, in the dust separating part 500 according to the first to fifth embodiments, a single second cyclone part 500b may be disposed at a center of the inside of the first cyclone part 500a, and a plurality of third cyclone parts 500c may be arranged in a circular shape around the second cyclone part 500b inside the first cyclone part 500a. That is, the third cyclone parts 500c may be arranged in a circular shape between the first cyclone part 500a and the second cyclone part 500b and spaced apart from one another in the circumferential direction.

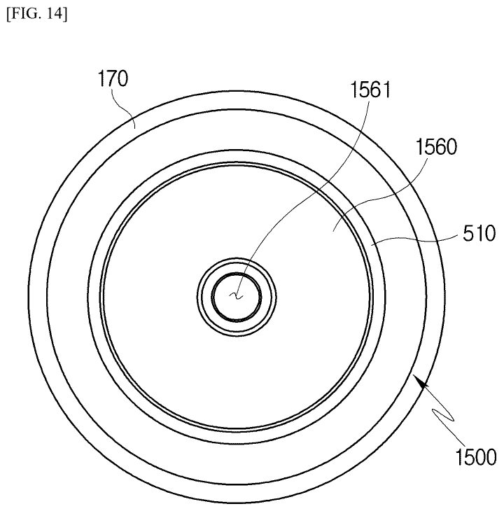

In another example, as illustrated in FIGS. 14 to 20, in a dust separating part 1500 according to the sixth to ninth embodiments, a single third cyclone part 1500c may be disposed at a center of the inside of a first cyclone part 1500a, and a plurality of second cyclone parts 1500b may be arranged in a circular shape around the third cyclone part 1500c inside the first cyclone part 1500a. That is, the second cyclone parts 1500b may be arranged in a circular shape between the first cyclone part 1500a and the third cyclone part 1500c and spaced apart from one another in the circumferential direction.

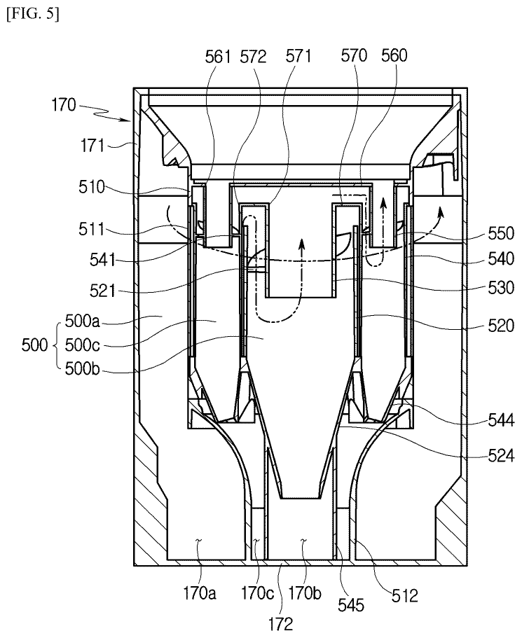

Meanwhile, FIG. 4 is a view for explaining the dust separating part of the cleaner according to the first to fifth embodiments of the present disclosure, and FIG. 5 is a cross-sectional view for explaining the dust separating part including an axial-flow type first cyclone unit and an axial-flow type second cyclone unit in the cleaner according to the first embodiment of the present disclosure.

The dust separating part 500 of the cleaner according to the first embodiment of the present disclosure will be described below with reference to FIGS. 4 and 5.

The dust separating part 500 may include a housing 510, a first cyclone unit, second cyclone units, a first separation wall 560, and a second separation wall 570.

The first cyclone part 500a may be formed between the dust bin 170 and the housing 510, the second cyclone part 500b may be formed by the first cyclone unit, and the third cyclone parts 500c may be formed by the plurality of second cyclone units.

In this case, the first cyclone part 500a may refer to a space in which the air sucked into the suction part 120 performs a primary cyclone flow, the second cyclone part 500b may refer to a space in which the air performs a secondary cyclone flow, and the third cyclone part 500c may refer to a space in which the air performs a tertiary cyclone flow. In addition, the air sucked into the suction part 120 is introduced into the dust bin 170 in a tangential direction, such that the first cyclone part 500a may provide a tangential inflow type primary cyclone structure.

In addition, the air having flowed through the first cyclone part 500a flows to a center of the housing 510, flows through the second cyclone part 500b, flows again in a radial direction from the center of the housing 510, flows through the third cyclone part 500c, and then is discharged.

Therefore, as illustrated in FIG. 4, when the dust bin 170 is viewed from the suction motor 140, the plurality of discharge ports 561 may be provided in a circular shape around the dust separating part 500 and spaced apart from one another in the circumferential direction.

In addition, with reference to FIG. 5, the dust bin 170 may have an approximately hollow cylindrical shape and provide a cylindrical space therein. The air introduced into the suction part 120 may flow into the dust bin 170. A central axis of the dust bin 170 may be disposed in parallel with an axis of the suction motor 140.

The housing 510 may have a hollow cylindrical shape, and the first cyclone unit and the second cyclone unit may be disposed inside the housing 510. The air having passed through the first cyclone part 500a may flow into the housing 510. A central axis of the housing 510 may be disposed in parallel with the central axis of the dust bin 170. In particular, the central axis of the housing 510 may be consistent with the central axis of the dust bin 170.

The first cyclone part 500a may be configured in an internal space of the housing 510 at a side adjacent to the suction motor 140, and a dust collecting space may be configured in an internal space at a side opposite to the suction motor 140. A specific configuration and effect of the dust collecting space will be described below in detail.

In addition, the housing 510 may have at least one through-hole 511 through which the air having passed through the first cyclone part 500a flows into the housing 510. The through-holes 511 may be formed through an inner peripheral surface and an outer peripheral surface of the housing 510 and spaced apart from one another at equal intervals along a periphery of the housing 510, and an interval between the through-holes 511 spaced apart from one another may be as narrow as possible.

The through-hole 511 is formed to provide a space through which dust-containing air may sufficiently pass. That is, a mesh filter in the related art is not installed in the housing 510, and the housing 510 may rather have the through-holes 511 and guide the air into the housing 510. Therefore, it is possible to prevent a situation in which the installation of the mesh filter in the housing 510 in the related art decreases a suction force, and particularly, a situation in which the mesh filter is temporarily or short-term clogged during durability progression, which causes the suction force to be significantly decreased.

The first cyclone unit is disposed inside the housing 510 and includes a first outer tube 520 and a first inner tube 530. A central axis of the first cyclone unit may be disposed in parallel with the central axis of the housing 510. In addition, the central axis of the first cyclone unit may be consistent with the central axis of the housing 510.

The first outer tube 520 may be disposed inside the housing 510 and define a hollow space between the first outer tube 520 and the housing 510. A space, through which the air flows, may be provided at an end of the first outer tube 520 adjacent to the suction motor 140. In addition, the second cyclone part 500b may be formed in the first outer tube 520, and the air having passed through the first cyclone part 500a is introduced into the second cyclone part 500b.

The first inner tube 530 is disposed inside the first outer tube 520 and has a central axis identical to a central axis of the first outer tube 520, and the first inner tube 530 discharges the air.

The first cyclone unit may include the first outer tube 520 and the first inner tube 530, and an inlet and an outlet of the second cyclone part 500b may be respectively disposed at an end of the first outer tube 520, which is adjacent to the suction motor 140, and an end of the first inner tube 530 adjacent to the suction motor 140.

The second cyclone part 500b may provide a first flow path through which the air introduced into the inlet flows along an axis parallel to a central axis of the primary cyclone flow, and a second flow path connected to the first flow path and configured to allow the air having passed through the first flow path to flow in a direction opposite to the first flow path and pass through the outlet. The second flow path is a flow path through which the air flows inside the first flow path along the axis parallel to the central axis of the primary cyclone flow while flowing in the direction opposite to the first flow path.

In addition, the first cyclone unit may be provided as an axial-flow type cyclone structure into which the air having passed through the first cyclone part 500a is introduced in the axial direction. The first cyclone unit may have a first guide vane 521 provided between the first outer tube 520 and the first inner tube 530.

The first guide vane 521 may be installed in the inlet of the second cyclone part 500b and include a plurality of blades each having a spiral shape. The first guide vane 521 may be provided at the end of the first outer tube 520 adjacent to the suction motor 140. The first guide vane 521 may extend from an inner peripheral surface of the first outer tube 520 to an outer peripheral surface of the first inner tube 530 and be formed to have a spiral shape.

Therefore, it is possible to induce a rotational flow in the air flowing into the first outer tube 520 along the end of the first outer tube 520 adjacent to the suction motor 140.

Meanwhile, the first outer tube 520 may have a first tapered portion 524 provided at the end opposite to the suction motor 140 and configured to guide dust, which is separated from the air, into the dust collecting space. The first tapered portion 524 may protrude from the end of the first outer tube 520 opposite to the suction motor 140, and a diameter of the first tapered portion 524 may gradually decrease toward the side opposite to the suction motor 140. Further, the dust having passed through the first tapered portion 524 falls into a second dust collecting portion 170b.

The second cyclone unit is disposed in a space between the housing 510 and the first cyclone unit and includes a second outer tube 540 and a second inner tube 550. A central axis of the second cyclone unit is disposed in parallel with the central axis of the housing 510. Further, the second cyclone units are provided as a plurality of second cyclone units, and the second cyclone units are arranged in a circular shape around the first cyclone unit in the circumferential direction.

In this case, separation spaces, through which the air having passed through the first cyclone part 500a may flow to the second cyclone part 500b, are provided between the plurality of second cyclone units. Specifically, the plurality of second cyclone units having the separation spaces through which the air having passed through the through-holes 511 may flow to the first cyclone unit. The separation spaces may be formed as the second cyclone units, which are adjacent to one another in the circumferential direction among the plurality of second cyclone units, are disposed to be spaced apart from one another. For example, the plurality of second cyclone units may be disposed such that two second cyclone units are in contact with each other in the circumferential direction, and the separation spaces may be provided between the second cyclone units.

The second outer tube 540 may be disposed in the axial direction and disposed in a hollow space between the housing 510 and the first cyclone unit. The third cyclone part 500c may be formed in the second outer tube 540, and the air having passed through the second cyclone part 500b is introduced into the third cyclone part 500c.

The plurality of second outer tubes 540 may be formed to have the same diameter and each have a diameter larger than a diameter of the first outer tube 520. The plurality of second inner tubes 550 to be described below may be formed to have the same diameter.

The second inner tube 550 is disposed inside the second outer tube 540 and has a central axis identical to a central axis of the second outer tube 540, and the second inner tube 550 discharges the air toward the suction motor 140.

The second cyclone unit may include the second outer tube 540 and the second inner tube 550, and an inlet and an outlet of the third cyclone part 500c may be respectively disposed at an end of the second outer tube 540, which is adjacent to the suction motor 140, and an end of the second inner tube 550 adjacent to the suction motor 140.

The third cyclone part 500c may provide a first flow path through which the air introduced into the inlet flows along an axis parallel to the central axis of the primary cyclone flow, and a second flow path connected to the first flow path and configured to allow the air having passed through the first flow path to flow in the direction opposite to the first flow path and pass through the outlet. The second flow path is a flow path through which the air flows inside the first flow path along the axis parallel to the central axis of the primary cyclone flow while flowing in the direction opposite to the first flow path.

In addition, the second cyclone unit may be provided as an axial-flow type cyclone structure into which the air having passed through the second cyclone part 500b is introduced in the axial direction. The second cyclone unit may have a second guide vane 541 provided between the second outer tube 540 and the second inner tube 550.

The second guide vane 541 may be installed in the inlet of the third cyclone part 500c and include a plurality of blades each having a spiral shape. The second guide vane 541 may be provided at the end of the second outer tube 540 adjacent to the suction motor 140. The second guide vane 541 may extend from an inner peripheral surface of the second outer tube 540 to an outer peripheral surface of the second inner tube 550 and be formed to have a spiral shape.

Therefore, it is possible to induce a rotational flow in the air flowing into the second outer tube 540 along the end of the second outer tube 540 adjacent to the suction motor 140.

Meanwhile, the second outer tube 540 may have second tapered portions 544 provided at the end opposite to the suction motor 140 and configured to guide dust, which is separated from the air, into the dust collecting space. The second tapered portion 544 may protrude from the end of the second outer tube 540 opposite to the suction motor 140, and a diameter of the second tapered portion 544 may gradually decrease toward the side opposite to the suction motor 140. Further, the dust having passed through the second tapered portion 544 falls into a third dust collecting portion 170c.

The first separation wall 560 is disposed inside the housing 510 and has a shape that blocks the space of the housing 510, and the first separation wall 560 has the discharge ports 561 connected to the outlet of the third cyclone part 500c.

The discharge ports 561 discharge the air, which has passed through the third cyclone parts 500c, toward the suction motor 140, and the plurality of discharge ports 561 are formed in the first separation wall 560 so that the plurality of second inner tubes 550 are connected to the plurality of discharge ports 561. The discharge ports 561 are provided in the first separation wall 560, spaced apart from one another in the circumferential direction, and arranged in a circular shape.

A flow space is formed between the second separation wall 570 and the first separation wall 560 and connects the outlet of the second cyclone part 500b and the inlet of the third cyclone part 500c. The second separation wall 570 may be provided inside the housing 510 and spaced apart from the first separation wall 560 to define the flow space.

The second separation wall 570 has an inner tube connection hole 571 connected to the outlet of the second cyclone part 500b, and a plurality of outer tube connection holes 572 connected to the inlet of the third cyclone part 500c.

The inner tube connection hole 571 may be formed at a center of the second separation wall 570 and connected to the first inner tube 530 to allow the air having passed through the second cyclone part 500b to flow.

The plurality of outer tube connection holes 572 are formed in the second separation wall 570 so that the plurality of second outer tubes 540 are connected to the plurality of outer tube connection holes 572. The plurality of outer tube connection holes 572 are provided in the second separation wall 570, spaced apart from one another in the circumferential direction, and arranged in a circular shape.

Therefore, the air having passed through the second cyclone part 500b may flow between the first separation wall 560 and the second separation wall 570 through the inner tube connection hole 571 and flow to the plurality of third cyclone parts 500c through the outer tube connection holes 572.

As a result, the air having passed through the first cyclone part 500a passes through the through-holes 511 of the housing 510, flows through the separation spaces between the plurality of second cyclone units, and flows to the separation space between the second separation wall 570 and the end of the first outer tube 520 adjacent to the suction motor 140. The air flows in the axial direction into the first outer tube 520 along the end of the first outer tube 520 adjacent to the suction motor 140, and the rotational flow is induced by the first guide vane 521. The air passes through the second cyclone part 500b and flows to the third cyclone part 500c through the space between the first separation wall 560 and the second separation wall 570. In this case, the air flows to the separation space between the first separation wall 560 and the end of the second outer tube 540 adjacent to the suction motor 140 and flows in the axial direction into the second outer tube 540 along the end of the second outer tube 540 adjacent to the suction motor 140. Further, the rotational flow is induced in the air by the second guide vane 541. The air passes through the third cyclone part 500c and is discharged toward the suction motor 140 through the discharge ports 561.

Meanwhile, the dust collecting space is provided at the side of the dust bin 170 adjacent to the discharge cover 172. In order to improve dust collecting performance, the dust collecting space has a first dust collecting portion 170a, the second dust collecting portion 170b, and the third dust collecting portion 170c that communicate with the first cyclone part 500a, the second cyclone part 500b, and the third cyclone part 500c.

That is, the dust collecting space may include the first dust collecting portion 170a, the second dust collecting portion 170b, and the third dust collecting portion 170c provided independently of one another.

Further, the first dust collecting portion 170a, the second dust collecting portion 170b, and the third dust collecting portion 170c may be disposed at the same height based on when the dust bin 170 is placed on the floor surface. When the discharge cover 172 is separated from the dust bin 170, the first dust collecting portion 170a, the second dust collecting portion 170b, and the third dust collecting portion 170c are opened downward.

The housing 510 has a dust collecting guide portion 512 extending from an end, which faces the discharge cover 172, toward the discharge cover 172 and having a diameter that decreases toward the discharge cover 172.

The dust collecting guide portion 512 may define the first dust collecting portion 170a outside the dust collecting guide portion 512 and define the second dust collecting portion 170b and the third dust collecting portion inside the dust collecting guide portion 512. Further, the dust collecting guide portion 512 may be formed to have a diameter that decreases toward the discharge cover 172, thereby ensuring the space of the first dust collecting portion 170a.

The first dust collecting portion 170a may provide a hollow cylindrical shape between the housing 510 and the dust collecting guide portion 512, and dust separated from the air passing through the first cyclone part 500a may fall and be collected.

The first outer tube 520 may have a hollow auxiliary dust collecting guide portion 545 formed outside the first tapered portion 524 and protruding toward the discharge cover 172.

The auxiliary dust collecting guide portion 545 may define the third dust collecting portion 170c outside the auxiliary dust collecting guide portion 545 and define the second dust collecting portion 170b inside the auxiliary dust collecting guide portion 545.

The second dust collecting portion 170b may be provided inside the auxiliary dust collecting guide portion 545 and communicate with the first tapered portion 524, and dust separated from the air passing through the second cyclone part 500b may fall and be collected.

The third dust collecting portion 170c may be provided between the dust collecting guide portion 512 and the auxiliary dust collecting guide portion 545 and communicate with the plurality of second tapered portions 544, and dust separated from the air passing through the third cyclone part 500c may fall and be collected.

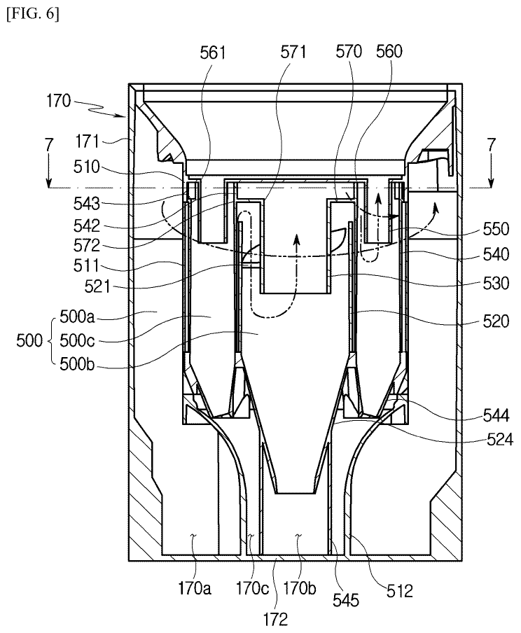

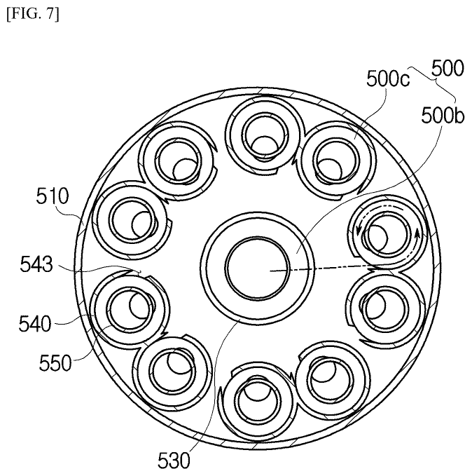

FIG. 6 is a cross-sectional view for explaining the dust separating part including an axial-flow type first cyclone unit and a tangential inflow type second cyclone unit in the cleaner according to the second embodiment of the present disclosure, and FIG. 7 is a cross-sectional view taken along line 7-7 in FIG. 6.

With reference to FIGS. 6 and 7, in the dust separating part 500 according to the second embodiment of the present disclosure, the first cyclone unit may be provided as an axial-flow type cyclone structure, and the second cyclone unit may be provided as a tangential inflow type cyclone structure.

In this case, the dust separating part 500 according to the second embodiment of the present disclosure is implemented by changing the structure of the second cyclone unit of the dust separating part 500 according to the first embodiment of the present disclosure to the tangential inflow type cyclone structure, and the components are identical, except for the air inflow structure of the second cyclone unit.

The second cyclone unit may be provided as the tangential inflow type cyclone structure into which the air having passed through the second cyclone part 500b is introduced in the tangential direction.

For example, the second cyclone unit may have a second extension end portion 542 and a second slit 543 formed in the second outer tube 540.

The second extension end portion 542 is provided as the end of the second outer tube 540 adjacent to the suction motor 140 passes through the second separation wall 570 and extends to the first separation wall 560. The second extension end portion 542 may be disposed to be in contact with the first separation wall 560. The second slit 543, into which the air is introduced, may be formed in an outer peripheral surface of the second extension end portion 542. In addition, the end of the second outer tube 540 adjacent to the suction motor 140 may be disposed to be in contact with the first separation wall 560, and at least one second slit 543 may be formed at the end of the second outer tube 540 provided to be in contact with the first separation wall 560.

With reference to FIG. 7, the second slit 543 may be a hole that allows the internal space of the second outer tube 540 to communicate with the flow space between the first separation wall 560 and the second separation wall 570. In this case, the second slit 543 is formed in the second extension end portion 542 between the first separation wall 560 and the second separation wall 570.

Specifically, the second extension end portion 542 may have a predetermined thickness, and a sidewall of the second slit 543 may be formed to define an inclined surface with a predetermined angle from an outer peripheral surface toward an inner peripheral surface of the second extension end portion 542. For example, the second slit 543 may be formed in the tangential direction of the cylindrical second extension end portion 542. In addition, when an imaginary central circle, which connects centers of the plurality of second cyclone units, is drawn, the second slit 543 may be disposed inside the imaginary central circle.

With this configuration, the air introduced into the second extension end portion 542 may generate a cyclone flow (spiral flow) while being introduced in the tangential direction of the second extension end portion 542.

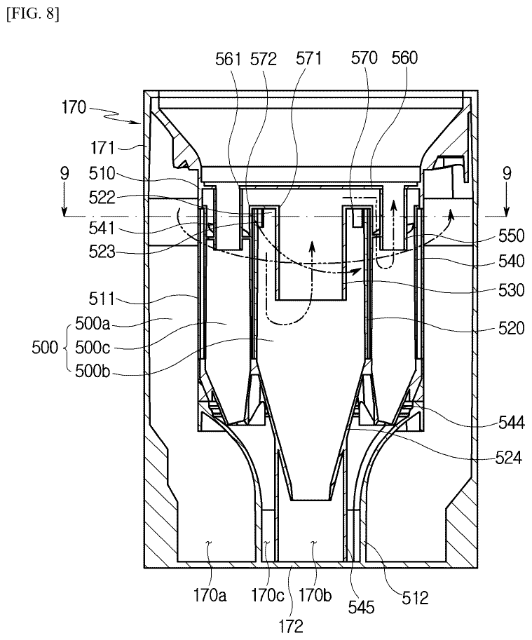

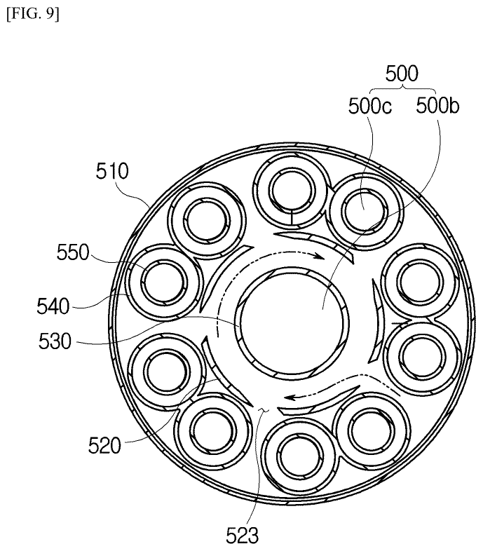

FIG. 8 is a cross-sectional view for explaining the dust separating part including a tangential inflow type first cyclone unit and an axial-flow type second cyclone unit in the cleaner according to the third embodiment of the present disclosure, and FIG. 9 is a cross-sectional view taken along line 9-9 in FIG. 8.

With reference to FIGS. 8 and 9, in the dust separating part 500 according to the third embodiment of the present disclosure, the first cyclone unit may be provided as a tangential inflow type cyclone structure, and the second cyclone unit may be provided as an axial-flow type cyclone structure.

In this case, the dust separating part 500 according to the third embodiment of the present disclosure is implemented by changing the structure of the first cyclone unit of the dust separating part 500 according to the first embodiment of the present disclosure to the tangential inflow type cyclone structure, and the components are identical, except for the air inflow structure of the first cyclone unit.

The second cyclone unit may be provided as the tangential inflow type cyclone structure into which the air having passed through the first cyclone part 500a is introduced in the tangential direction.

For example, the first cyclone unit may have a first extension end portion 522 and a first slit 523 formed in the first outer tube 520.

The first extension end portion 522 is provided as the end of the first outer tube 520 adjacent to the suction motor 140 extends to the second separation wall 570. The first extension end portion 522 may be disposed to be in contact with the second separation wall 570. The first slit 523, into which the air is introduced, may be formed in an outer peripheral surface of the first extension end portion 522. In addition, the end of the first outer tube 520 adjacent to the suction motor 140 may be disposed to be in contact with the second separation wall 570, and at least one second slit 543 may be formed at the end of the first outer tube 520 provided to be in contact with the second separation wall 570.

With reference to FIG. 9, the first slit 523 may be a hole that allows the internal space of the first outer tube 520 to communicate with the internal space of the housing 510. In this case, the first slit 523 is formed in the first extension end portion 522.

Specifically, the first extension end portion 522 may have a predetermined thickness, and a sidewall of the first slit 523 may be formed to define an inclined surface with a predetermined angle from an outer peripheral surface toward an inner peripheral surface of the first extension end portion 522. For example, the first slit 523 may be formed in the tangential direction of the cylindrical first extension end portion 522.

At least one first slit 523 may be formed in the circumferential direction of the first extension end portion 522. For example, five first slits 523 may be formed at intervals of 72 degrees in the circumferential direction of the first extension end portion 522. In another example, four first slits 523 may be formed at intervals of 90 degrees in the circumferential direction of the first extension end portion 522. In still another example, three first slits 523 may be formed at intervals of 120 degrees in the circumferential direction of the first extension end portion 522. In yet another example, two first slits 523 may be formed at an interval of 180 degrees in the circumferential direction of the first extension end portion 522.

With this configuration, the air introduced into the first extension end portion 522 may generate a cyclone flow (spiral flow) while being introduced in the tangential direction of the first extension end portion 522.

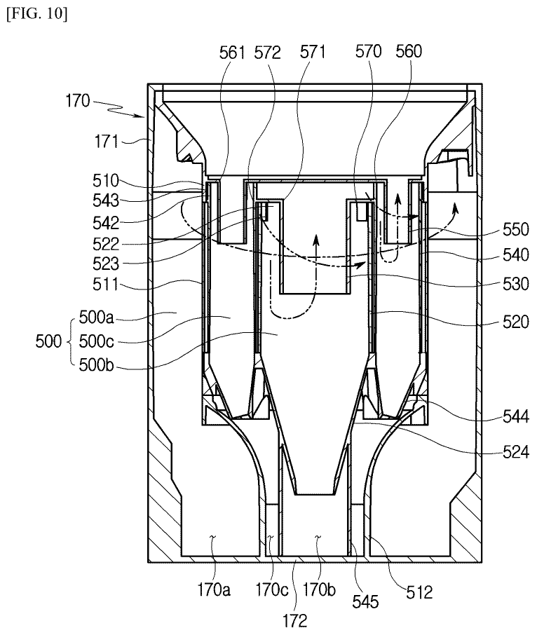

FIG. 10 is a cross-sectional view for explaining the dust separating part including a tangential inflow type first cyclone unit and a tangential inflow type second cyclone unit in the cleaner according to the fourth embodiment of the present disclosure.

With reference to FIG. 10, in the dust separating part 500 according to the fourth embodiment of the present disclosure, the first and second cyclone units may be provided as tangential inflow type cyclone structures.

That is, the dust separating part 500 according to the fourth embodiment of the present disclosure is implemented by changing the first cyclone unit of the dust separating part 500 according to the first embodiment of the present disclosure to the first cyclone unit according to the third embodiment and changing the second cyclone unit to the second cyclone unit according to the second embodiment.

The first and second cyclone units each have a structure into which the air is introduced in the tangential direction. Specifically, as illustrated in FIGS. 7 and 9, the first cyclone unit may have the first extension end portion 522 and the first slit 523, and the second cyclone unit may have the second extension end portion 542 and the second slit 543.

With this configuration, the air introduced into the second cyclone part 500b may pass through the first slit 523 and perform the cyclone flow while being introduced in the tangential direction of the first extension end portion 522, and the air introduced into the third cyclone part 500c may pass through the second slit 543 and perform the cyclone flow while being introduced in the tangential direction of the second extension end portion 542.

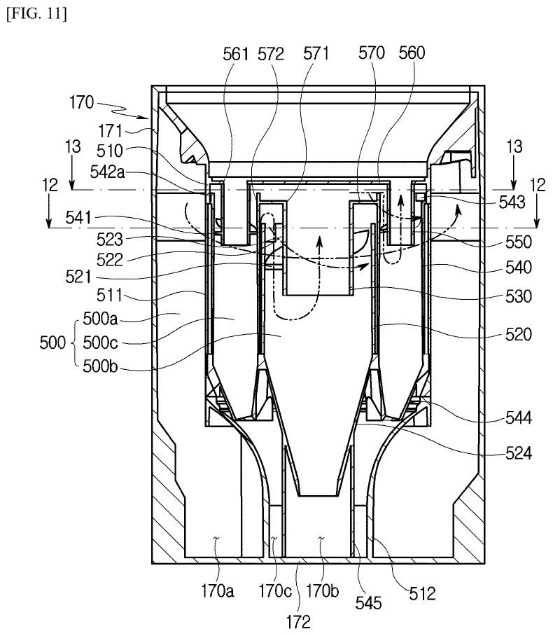

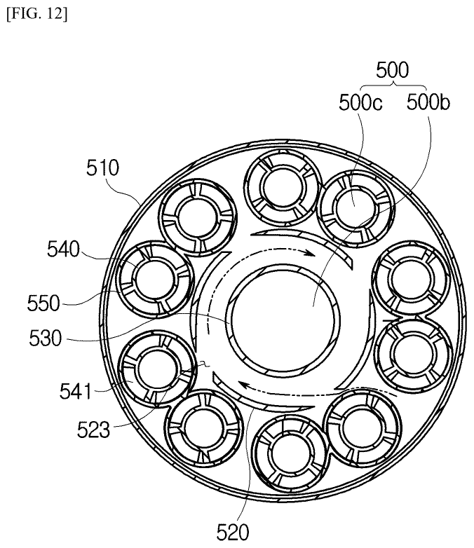

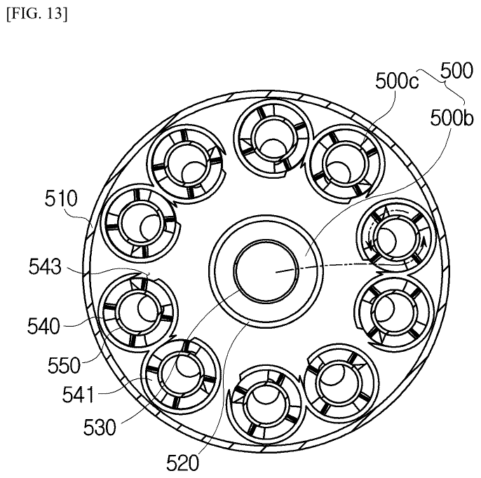

In addition, FIG. 11 is a cross-sectional view for explaining the dust separating part including a tangential axial-flow type first cyclone unit and a tangential axial-flow type second cyclone unit in the cleaner according to the fifth embodiment of the present disclosure, FIG. 12 is a cross-sectional view taken along line 12-12 in FIG. 11, and FIG. 13 is a cross-sectional view taken along line 13-13 in FIG. 11.

With reference to FIGS. 11 to 13, the dust separating part 500 according to the fifth embodiment of the present disclosure is implemented by additionally applying a tangential inflow structure to the air inflow structures of the first and second cyclone units of the dust separating part 500 according to the first embodiment of the present disclosure.

For example, with reference to FIGS. 11 and 12, the first outer tube 520 is disposed to be spaced apart from the second separation wall 570, and the first slit 523 is formed at the end facing the second separation wall 570. Further, the first outer tube 520 may have the first guide vane 521 protruding toward the first inner tube 530.

With this configuration, the air having passed between the first outer tube 520 and the second separation wall 570 passes through the first guide vane 521, thereby inducing a spiral flow. In addition, after the spiral flow is induced by the first slit 523, the air having passed through the first slit 523 may more strongly flow spirally while flowing along the first guide vane 521. That is, the first guide vane 521 may increase an angular velocity of the air and thus increase a centrifugal force of the air.

In addition, with reference to FIGS. 11 and 13, the second outer tube 540 may have the second extension end portion 542a protruding toward the first separation wall 560 and spaced apart from the first separation wall 560, and the second slit 543 formed in the second extension end portion 542a. That is, the end of the second outer tube 540 is connected to the second separation wall 570, and the second slit 543 is provided in the second extension end portion 542a protruding from the end of the second outer tube 540 toward an upper side of the second separation wall 570. The second slit 543 allows the internal space of the second extension end portion 542a to communicate with the flow space between the first separation wall 560 and the second separation wall 570. In addition, the second extension end portion 542a is separated from the first separation wall 560, such that the air having flowed through the second cyclone part 500b may be introduced into the internal space of the second extension end portion 542a along the second extension end portion 542a. Further, the second outer tube 540 may further have the second guide vane 541 protruding toward the second inner tube 550.

With this configuration, the air, which is introduced into the second outer tube 540 along the second extension end portion 542a, passes through the second guide vane 541, thereby inducing a spiral flow. In addition, after the spiral flow is induced by the second slit 543, the air having passed through the second slit 543 may more strongly flow spirally while flowing along the second guide vane 541. That is, the second guide vane 541 may increase an angular velocity of the air and thus increase a centrifugal force of the air.

Therefore, the first and second cyclone units according to the embodiment of the present disclosure have the guide vanes 521 and 541 as well as the slits 523 and 543 to induce the spiral flow of the air and further accelerate the rotational force, thereby increasing the centrifugal force and further improving performance in separating the dust.

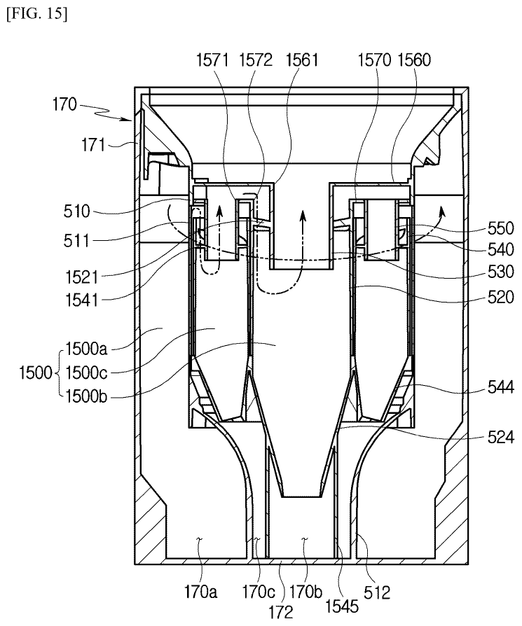

FIG. 14 is a view for explaining the dust separating part of the cleaner according to the sixth to ninth embodiments of the present disclosure, and FIG. 15 is a cross-sectional view for explaining the dust separating part including an axial-flow type first cyclone unit and an axial-flow type second cyclone unit in the cleaner according to the sixth embodiment of the present disclosure.

Because the dust bin 170 and the housing 510 of the dust separating part 1500 according to the sixth to ninth embodiments of the present disclosure are identical in structures to the dust bin 170 and the housing 510 of the dust separating part 500 according to the first to fifth embodiments of the present disclosure, a specific description will be omitted.

In addition, in the dust separating part 1500 according to the sixth to ninth embodiments of the present disclosure, the third cyclone part 1500c may be formed by the first cyclone unit, and the second cyclone part 1500b may be formed by the plurality of second cyclone units.

With this structure, the air having flowed through the first cyclone part 1500a flows through the second cyclone part 1500b at a position spaced apart radially inward from the inner peripheral surface of the housing 510, flows to the center of the housing 510, flows through the third cyclone part 1500c, and then is discharged.

Therefore, as illustrated in FIG. 14, when the dust bin 170 is viewed from the suction motor 140, a single discharge port 1561 may be disposed at a center of the housing 510 of the dust separating part 1500.

In addition, with reference to FIG. 15, the dust separating part 1500 includes a first outer tube 1520, a first inner tube 1530, a second outer tube 1540, and second inner tubes 1550 identical in structures to the first outer tube 520, the first inner tube 530, the second outer tube 540, and the second inner tube 550 of the dust separating part 500 according to the first embodiment, the single discharge port 1561 is formed in a first separation wall 1560, and a second separation wall 1570 is connected to the second inner tubes 1550 and the first outer tube 1520.

The first cyclone unit may be disposed at the center of the housing 510 and provide the third cyclone part 1500c.

The third cyclone part 1500c may be formed in the first outer tube 1520, the air having passed through the second cyclone part 1500b is introduced toward the side opposite to the suction motor 140, and the first inner tube 1530 discharges the air to the outside.

In addition, the first cyclone unit may be provided as an axial-flow type cyclone structure into which the air having passed through the second cyclone part 1500b is introduced in the axial direction. The first cyclone unit may have a first guide vane 1521 provided between the first outer tube 1520 and the first inner tube 1530.

The first guide vane 1521 may be installed in the inlet of the third cyclone part 1500c and include a plurality of blades each having a spiral shape. The first guide vane 1521 may be provided at the end of the first outer tube 1520 adjacent to the suction motor 140. The first guide vane 1521 may extend from an inner peripheral surface of the first outer tube 1520 to an outer peripheral surface of the first inner tube 1530 and be formed to have a spiral shape.

Therefore, it is possible to induce a rotational flow in the air flowing into the first outer tube 1520 along the end of the first outer tube 1520 adjacent to the suction motor 140.

Meanwhile, the first outer tube 1520 may have a first tapered portion 1524 provided at the end opposite to the suction motor 140 and configured to guide dust, which is separated from the air, into the dust collecting space. The dust having passed through the first tapered portion 1524 falls into the third dust collecting portion 170c.

The second cyclone units are provided as a plurality of second cyclone units in the space between the housing 510 and the first cyclone unit and arranged in a circular shape in the circumferential direction. The second cyclone unit may provide the second cyclone part 1500b.

The plurality of second cyclone units may be arranged to adjoin the second cyclone units adjacent in the circumferential direction in order to maximally utilize the space between the housing 510 and the first cyclone unit. Further, the central axes of the plurality of second cyclone units may be arranged to be spaced apart from one another at equal intervals in the circumferential direction.

The second cyclone part 1500b may be formed in the second outer tube 1540, the air having passed through the first cyclone part 1500a is introduced toward the side opposite to the suction motor 140, and the second inner tube 1550 discharges the air to the outside.

Meanwhile, the second outer tube 1540 may have second tapered portions 1544 provided at the end opposite to the suction motor 140 and configured to guide dust, which is separated from the air, into the dust collecting space. The dust having passed through the second tapered portion 1544 falls into the second dust collecting portion 170c.

In addition, the second cyclone unit may be provided as an axial-flow type cyclone structure into which the air having passed through the first cyclone part 1500a is introduced in the axial direction. The second cyclone unit may have a second guide vane 1541 between the second outer tube 1540 and the second inner tube 1550.

The second guide vane 1541 may be installed in the inlet of the second cyclone part 1500b and include a plurality of blades each having a spiral shape. The second guide vane 1541 may be provided at the end of the second outer tube 1540 adjacent to the suction motor 140. The second guide vane 1541 may extend from an inner peripheral surface of the second outer tube 1540 to an outer peripheral surface of the second inner tube 1550 and be formed to have a spiral shape.

Therefore, it is possible to induce a rotational flow in the air flowing into the second outer tube 1540 along the end of the second outer tube 1540 adjacent to the suction motor 140.

Meanwhile, the second outer tube 1540 may have the second tapered portions 1544 provided at the end opposite to the suction motor 140 and configured to guide dust, which is separated from the air, into the dust collecting space. The dust having passed through the second tapered portion 1544 falls into the second dust collecting portion 170b.

The first separation wall 1560 is disposed inside the housing 510 and has a shape that blocks the space of the housing 510, and the first separation wall 1560 has the discharge port 1561 connected to the outlet of the third cyclone part 1500c.

The discharge port 1561 discharges the air, which has passed through the third cyclone part 1500c, toward the suction motor 140 and is formed at the center of the first separation wall 1560 so that the first inner tube 1530 is connected to the discharge port 1561.

A flow space is formed between the second separation wall 1570 and the first separation wall 1560 and connects the outlet of the second cyclone part 1500b and the inlet of the third cyclone part 1500c. The second separation wall 1570 may be provided inside the housing 510 and spaced apart from the first separation wall 1560 to define the flow space.

The second separation wall 1570 has a plurality of inner tube connection holes 1571 connected to the outlet of the second cyclone part 1500b, and an outer tube connection hole 1572 connected to the inlet of the third cyclone part 1500c.

The inner tube connection holes 1571 are provided as a plurality of inner tube connection holes 1571 formed in the second separation wall 1570, spaced apart from one another in the circumferential direction of the second separation wall 1570, arranged in a circular shape, and connected to the plurality of second inner tubes 1550, and the air having passed through the second cyclone part 1500b flows.

The outer tube connection hole 1572 may be formed at a center of the second separation wall 1570 and connected to the first outer tube.

Therefore, the air having passed through the second cyclone part 1500b may flow between the first separation wall 1560 and the second separation wall 1570 through the inner tube connection hole 1571 and flow to the plurality of third cyclone parts 1500c through the outer tube connection hole 1572.

As a result, the air having passed through the first cyclone part 1500a passes through the through-holes 511 of the housing 510 and flows to the separation space between the second separation wall 1570 and the end of the first outer tube 1520 adjacent to the suction motor 140. The air flows in the axial direction into the second outer tube 1540 along the end of the second outer tube 1540 adjacent to the suction motor 140, and the rotational flow is induced by the second guide vane 1541. The air passes through the second cyclone part 1500b and flows to the third cyclone part 1500c through the space between the first separation wall 1560 and the second separation wall 1570. In this case, the air flows to the separation space between the first separation wall 1560 and the end of the first outer tube 1520 adjacent to the suction motor 140 and flows in the axial direction into the first outer tube 1520 along the end of the first outer tube 1520 adjacent to the suction motor 140. Further, the rotational flow is induced in the air by the first guide vane 1521. The air passes through the third cyclone part 1500c and is discharged toward the suction motor 140 through the discharge port 1561.

Meanwhile, the dust collecting space is provided at the side of the dust bin 170 adjacent to the discharge cover. In order to improve dust collecting performance, the dust collecting space has the first dust collecting portion 170a, the second dust collecting portion 170b, and the third dust collecting portion 170c that communicate with the first cyclone part 1500a, the second cyclone part 1500b, and the third cyclone part 1500c.

That is, the dust collecting space may include the first dust collecting portion 170a, the second dust collecting portion 170b, and the third dust collecting portion 170c provided independently of one another.

Further, the first dust collecting portion 170a, the second dust collecting portion, and the third dust collecting portion 170c may be disposed at the same height based on when the dust bin 170 is placed on the floor surface. When the discharge cover is separated from the dust bin 170, the first dust collecting portion 170a, the second dust collecting portion, and the third dust collecting portion 170c are opened downward.

The dust collecting guide portion 512 may define the first dust collecting portion 170a outside the dust collecting guide portion 512 and define the second dust collecting portion 170b and the third dust collecting portion inside the dust collecting guide portion 512.

The first outer tube 1520 may have a hollow auxiliary dust collecting guide portion 1545 formed outside the first tapered portion 1524 and protruding toward the discharge cover.

The auxiliary dust collecting guide portion 1545 may define the second dust collecting portion 170b outside the auxiliary dust collecting guide portion 1545 and define the third dust collecting portion 170c inside the auxiliary dust collecting guide portion 1545.

The second dust collecting portion 170b may be provided between the dust collecting guide portion 512 and the auxiliary dust collecting guide portion 1545 and communicate with the plurality of second tapered portions 544, and dust separated from the air passing through the second cyclone part 1500b may fall and be collected.

The third dust collecting portion 170c may be provided inside the auxiliary dust collecting guide portion 1545 and communicate with the first tapered portion 1524, and dust separated from the air passing through the third cyclone part 1500c may fall and be collected.

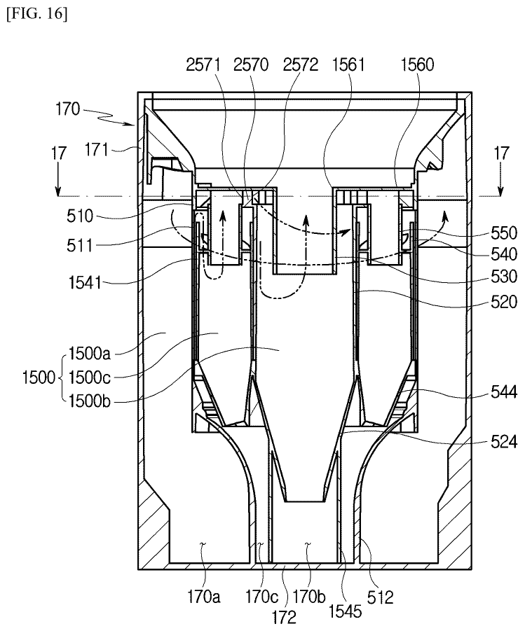

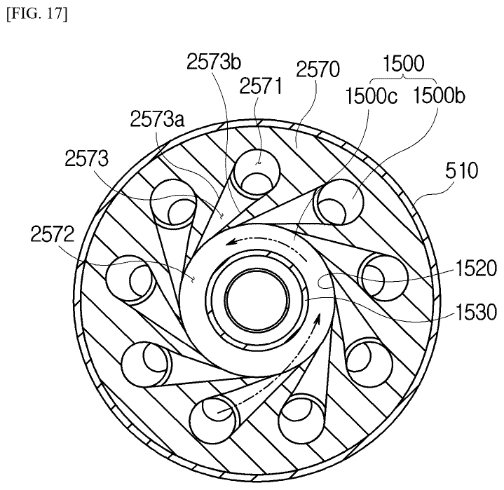

FIG. 16 is a cross-sectional view for explaining the dust separating part including a tangential inflow type first cyclone unit and an axial-flow type second cyclone unit in the cleaner according to the seventh embodiment of the present disclosure, and FIG. 17 is a cross-sectional view taken along line 17-17 in FIG. 16.

With reference to FIGS. 16 and 17, in the dust separating part 1500 according to the seventh embodiment of the present disclosure, the first cyclone unit may be provided as a tangential inflow type cyclone structure, and the second cyclone unit may be provided as an axial-flow type cyclone structure.

In this case, the dust separating part 1500 according to the seventh embodiment of the present disclosure is implemented by changing the structure of the first cyclone unit of the dust separating part 1500 according to the sixth embodiment of the present disclosure to the tangential inflow type cyclone structure, and the components are identical, except for the air inflow structure of the first cyclone unit.

The first cyclone unit may be provided as the tangential inflow type cyclone structure into which the air having passed through the second cyclone part 1500b is introduced in the tangential direction.

In this case, because the third cyclone part 1500c is positioned radially inward of the second cyclone part 1500b, a guide structure is required to introduce the air, which has passed through the second cyclone part 1500b, into the third cyclone part 1500c in the tangential direction.

For example, a flow space is formed between a second separation wall 2570 and the first separation wall 1560 and connects the outlet of the second cyclone part 1500b and the inlet of the third cyclone part 1500c, and the flow space may be an internal space of a guide groove 2573 to be described below.

The first separation wall 1560 is disposed to be in contact with the second separation wall 2570, and the discharge port 1561 is formed at the center of the first separation wall 1560 and communicates with the first inner tube 1530.

The second separation wall 2570 has a predetermined thickness and is provided with inner tube connection holes 2571 and an outer tube connection hole 2572 formed through two opposite surfaces of the second separation wall 2570. The inner tube connection holes 2571 are provided as a plurality of inner tube connection holes 2571 connected to communicate with the second inner tube 1550, and the outer tube connection hole 2572 is connected to communicate with the first outer tube 1520.

Further, the second separation wall 2570 has the guide groove 2573 recessed in a surface, with which the first separation wall 1560 is in contact, and formed to allow the inner tube connection hole 2571 and the outer tube connection hole 2572 to communicate with each other.

The guide groove 2573 may be formed in the second separation wall 2570 and provided as a plurality of guide grooves 2573 to allow the plurality of inner tube connection holes 2571 to communicate with the outer tube connection hole 2572.

Further, the guide groove 2573 is formed to guide the air in the tangential direction of the first outer tube 1520 and has a width that gradually decreases from the inner tube connection hole 2571 toward the outer tube connection hole 2572.

Specifically, the guide groove 2573 may have a first wall surface 2573a and a second wall surface 2573b that are flat inner surfaces that connect the inner tube connection hole 2571 and the outer tube connection hole 2572. Further, the first wall surface 2573a and the second wall surface 2573b are formed such that a distance between the first wall surface 2573a and the second wall surface 2573b decreases toward the outer tube connection hole 2572. In addition, the first wall surface 2573a and the second wall surface 2573b may each be disposed in the tangential direction of the first outer tube 1520.

With this configuration, the air, which is discharged from the second cyclone part 1500b and introduced into the guide groove 2573, may be guided by the first wall surface 2573a and the second wall surface 2573b and perform the cyclone flow (spiral flow) while being introduced into the first outer tube 1520 in the tangential direction.

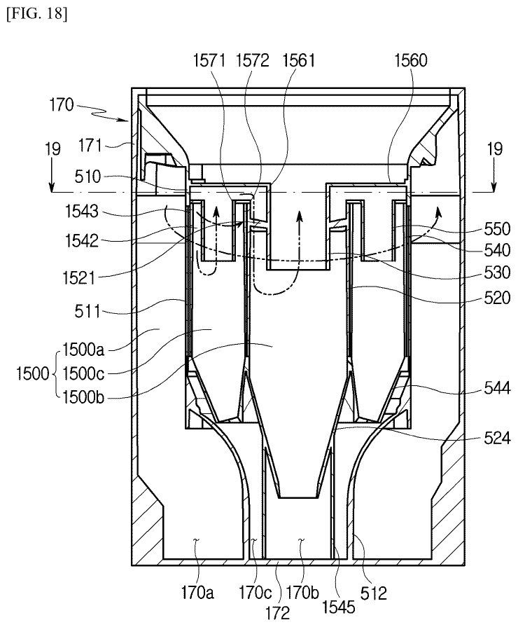

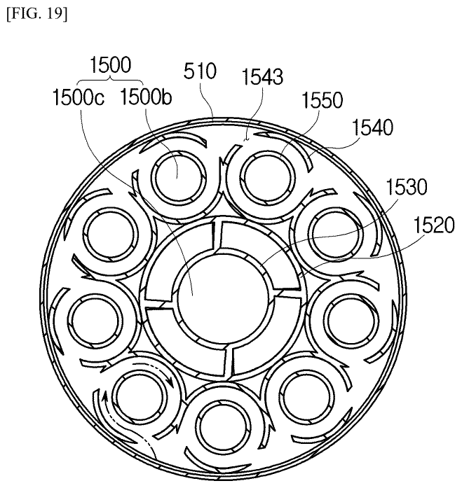

FIG. 18 is a cross-sectional view for explaining the dust separating part including an axial-flow type first cyclone unit and a tangential inflow type second cyclone unit in the cleaner according to the eighth embodiment of the present disclosure, and FIG. 19 is a cross-sectional view taken along line 19-19 in FIG. 18.

With reference to FIGS. 18 and 19, in the dust separating part 1500 according to the eighth embodiment of the present disclosure, the second cyclone unit may be provided as a tangential inflow type cyclone structure, and the first cyclone unit may be provided as an axial-flow type cyclone structure.

In this case, the dust separating part 1500 according to the eighth embodiment of the present disclosure is implemented by changing the structure of the second cyclone unit of the dust separating part 1500 according to the sixth embodiment of the present disclosure to the tangential inflow type cyclone structure, and the components are identical, except for the air inflow structure of the second cyclone unit.

The second cyclone unit may be provided as the tangential inflow type cyclone structure into which the air having passed through the second cyclone part 1500b is introduced in the tangential direction.

For example, the second cyclone unit may have a second extension end portion 1542 and at least one second slit 1543 formed in the second outer tube 1540.

The second extension end portion 1542 is provided as the end of the second outer tube 1540 adjacent to the suction motor 140 extends to the second separation wall 1570. The second extension end portion 1542 may be disposed to be in contact with the second separation wall 1570. At least one second slit 1543, into which the air is introduced, may be formed in an outer peripheral surface of the second extension end portion 1542. In addition, the end of the second outer tube 1540 adjacent to the suction motor 140 may be disposed to be in contact with the second separation wall 1570, and at least one second slit 1543 may be formed at the end of the second outer tube 1540 provided to be in contact with the second separation wall 1570.

With reference to FIG. 19, the second slit 1543 may be a hole that allows the internal space of the second outer tube 1540 to communicate with the flow space between the first separation wall 1560 and the second separation wall 1570. In this case, the second slit 1543 is formed in the second extension end portion 1542 between the first separation wall 1560 and the second separation wall 1570.

Specifically, the second extension end portion 1542 may have a predetermined thickness, and a sidewall of the second slit 1543 may be formed to define an inclined surface with a predetermined angle from an outer peripheral surface toward an inner peripheral surface of the second extension end portion 1542. For example, the second slit 1543 may be formed in the tangential direction of the cylindrical second extension end portion 1542. In addition, when an imaginary central circle, which connects centers of the plurality of second cyclone units, is drawn, the second slit 1543 may be disposed outside the imaginary central circle.

With this configuration, the air introduced into the second extension end portion 1542 may generate a cyclone flow (spiral flow) while being introduced in the tangential direction of the second extension end portion 1542.

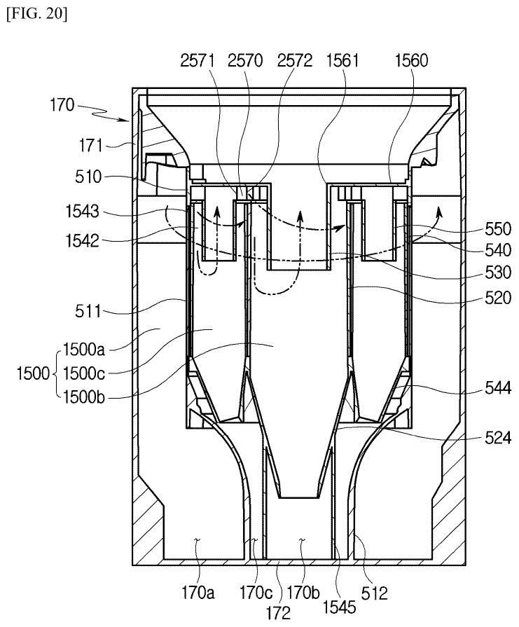

FIG. 20 is a cross-sectional view for explaining the dust separating part including a tangential inflow type first cyclone unit and a tangential inflow type second cyclone unit in the cleaner according to the ninth embodiment of the present disclosure.

With reference to FIG. 20, in the dust separating part 1500 according to the ninth embodiment of the present disclosure, the first and second cyclone units may be provided as tangential inflow type cyclone structures.

That is, the dust separating part 1500 according to the ninth embodiment of the present disclosure is implemented by changing the first cyclone unit of the dust separating part 1500 according to the sixth embodiment of the present disclosure to the first cyclone unit according to the seventh embodiment and changing the second cyclone unit to the second cyclone unit according to the eighth embodiment.

In the dust separating part 1500, the first separation wall 1560 is disposed to be in contact with the second separation wall 2570, and the guide groove 2573 is formed in the second separation wall 2570. Further, as illustrated in FIG. 18, the second cyclone unit has the second extension end portion 1542 and the second slit 1543.

With this configuration, the air introduced into the second cyclone part 1500b may pass through the second slit 1543 and perform the cyclone flow while being introduced in the tangential direction of the second extension end portion 1542, and the air introduced into the third cyclone part 1500c may flow along the guide groove 2573 and perform the cyclone flow while being introduced in the tangential direction of the first outer tube 1520.

While the specific embodiments of the present disclosure have been described and illustrated, it is obvious to those skilled in the art that the present disclosure is not limited to the aforementioned embodiments and may be variously changed and modified without departing from the spirit and the scope of the present disclosure. Therefore, the scope of the present disclosure should be determined by the technical spirit of the appended claims instead of being determined by the described embodiment.

1. A cleaner comprising:
a suction part having a flow path through which air flows;
a dust separating part configured to separate dust from air sucked through the suction part; and
a suction motor configured to provide a flow force of air,
wherein the dust separating part comprises:
a first cyclone part configured to separate debris from the air sucked into the suction part;
a second cyclone part configured to separate debris from the air having passed through the first cyclone part; and
a third cyclone part configured to separate debris from the air having passed through the second cyclone part,
wherein any one of the second cyclone part and the third cyclone part is disposed to surround the other of the second cyclone part and the third cyclone part, and
wherein the first cyclone part is disposed to surround any one of the second cyclone part and the third cyclone part.

2. The cleaner of claim 1, wherein the second and third cyclone parts each comprise:
a first flow path through which the air flows along an axis parallel to a central axis of a cyclone flow; and
a second flow path through which the air flows along an axis parallel to a central axis of a cyclone flow while flowing in a direction opposite to the first flow path, the second flow path being connected to the first flow path.

3. The cleaner of claim 2, wherein the air having passed through the first cyclone part is introduced into the second cyclone part in an axial direction.

4. The cleaner of claim 3, wherein the air having passed through the second cyclone part is introduced into the third cyclone part in the axial direction or a tangential direction.

5. The cleaner of claim 2, wherein the air having passed through the first cyclone part is introduced into the second cyclone part in a tangential direction.

6. The cleaner of claim 5, wherein the air having passed through the second cyclone part is introduced into the third cyclone part in an axial direction or the tangential direction.

7. The cleaner of claim 1, wherein the dust separating part has a plurality of discharge ports configured to discharge the air having passed through the third cyclone part, and the discharge ports are arranged in the dust separating part in a circumferential direction.

8. The cleaner of claim 1, wherein the dust separating part has a discharge port configured to discharge the air having passed through the third cyclone part, and the discharge port is formed at a center of the dust separating part.

9. The cleaner of claim 1, wherein the dust separating part further comprises:
a first outer tube configured to provide any one of the second cyclone part and the third cyclone part;
a first inner tube disposed inside the first outer tube;
a plurality of second outer tubes arranged in a circumferential direction around the first outer tube and configured to provide the other of the second cyclone part and the third cyclone part; and
a plurality of second inner tubes respectively disposed inside the second outer tubes.

10. The cleaner of claim 9, wherein the dust separating part further comprises:
a first separation wall having a discharge port configured to discharge the air, which has passed through the third cyclone part, toward the suction motor; and
a second separation wall configured to connect the first inner tube and the second outer tube and define a flow space together with the first separation wall, and
wherein the air having passed through the second cyclone part flows to the third cyclone part through the flow space.

11. The cleaner of claim 9, wherein the dust separating part further comprises:
a first separation wall having a discharge port configured to discharge the air having passed through the third cyclone part; and
a second separation wall configured to connect the second inner tube and the first outer tube and define a flow space together with the first separation wall, and
wherein the air having passed through the second cyclone part flows to the third cyclone part through the flow space.

12. The cleaner of claim 11, wherein the first separation wall is disposed to be in contact with the second separation wall,
wherein the second separation wall has a plurality of guide grooves recessed in a surface, with which the first separation wall is in contact, and formed to allow the plurality of second inner tubes and the first outer tube to communicate with one another, and
wherein a width of the guide groove gradually decreases from the second inner tube toward the first outer tube.

13. The cleaner of claim 9, wherein the dust separating part further comprises a housing in which the plurality of second outer tubes are disposed, the housing having at least one through-hole through which the air having passed through the first cyclone part flows.

14. The cleaner of claim 9, wherein an inlet and an outlet of each of the second and third cyclone parts are disposed at an end of the outer tube adjacent to the suction motor.

15. The cleaner of claim 9, wherein the outer tube has a guide vane having a spiral shape and protruding from an inner peripheral surface of the outer tube toward the inner tube.

16. The cleaner of claim 9, wherein the outer tube has at least one slit provided at an end of the outer tube adjacent to the suction motor.

17. The cleaner of claim 9, wherein the first outer tube is formed to have a diameter larger than a diameter of the second outer tube.
